(19) United States
(12) Patent Application Publication
(10) Pub. No.: US 2018/0045527 A1
(43) Pub. Date: Feb. 15, 2018

(54) Systems and Methods for Predicting Vehicle Fuel Consumption

(71) Applicant: Milemind, LLC, Durham, NC (US)

(72) Inventors: Douglas Dane Baker, Apex, NC (US); Saeed Afshari, Walferdange (LU); Nicholas Lucchesi, Cary, NC (US)

(73) Assignee: Milemind, LLC, Durham, NC (US)

(21) Appl. No.: 15/723,775

(22) Filed: Oct. 3, 2017

Related U.S. Application Data
(63) Continuation-in-part of application No. 15/423,754, filed on Feb. 3, 2017.
(60) Provisional application No. 62/373,100, filed on Aug. 10, 2016.

(51) Int. Cl. G01C 21/34; G01C 21/36

(52) U.S. Cl. CPC G01C 21/3469; G01C 21/3484; G01C 21/3492; G01C 21/3617

(57) ABSTRACT

Systems and methods for predicting fuel consumption for a vehicle for a route from an origination point to a desired destination are described. The method uses contextual driving mapping information and information related the vehicle to estimate the fuel consumption along segments of the route. Each of the segments may be added together to estimate the fuel consumption along the entire route.

### CROSS-REFERENCE TO RELATED APPLICATIONS

This application claims priority under 35 U.S.C. §120 as a continuation-in-part patent application to U.S. patent application Ser. No. 15/423,754 filed Feb. 3, 2017 and U.S. Provisional Patent Application No. 62/373,100, filed on Aug. 10, 2016, the complete disclosure of which is incorporated herein by reference in its entirety.

### BACKGROUND OF THE INVENTION

### Field of the Invention

The present invention generally relates to systems and methods for estimating vehicle fuel consumption for at least one route from an origination point to a destination point.

### Description of the Related Art

The efficient utilization of energy resources associated with the transportation of people and goods has been of great concern among government agencies, industry and society in general. The costs of fossil fuels, together with environmental problems and atmospheric pollution, has encouraged the development and marketing of energy efficient vehicles, using strategies such as: (i) reducing the rolling resistance of tires, (ii) reducing mass and the aerodynamic drag factor of the vehicle, (iii) increasing the energy efficiency of the vehicle powertrain (engine, transmission, etc.), (iv) the hybridization of the vehicle through the electric propulsion, etc.

People would like to estimate the cost of fuel from a starting point to a destination point for various reasons. They may wish to compare the fuel consumption along two routes to a desired destination; understand the overall cost of traveling or to accurately share the cost of driving among passengers.

Various methods have been developed to estimate the fuel consumption in driving from on origination point and a destination point. There exists a need for an efficient method and cost-effective systems for estimating fuel consumption from a starting point to a destination point.

### SUMMARY

Current systems and methods for fuel consumption estimation require detailed information concerning a defined route to be traveled and detailed information concerning the specific vehicle to be driven. The inventors have surprisingly found a simple algorithm based upon fuzzy mathematics to estimate the fuel consumption along a defined route by a vehicle with readily available information. The systems and methods can estimate the fuel that would be consumed from information obtained from a route mapping API and the fuel consumption characteristics of the vehicle.

Systems and methods for predicting fuel consumption for a vehicle are disclosed. In one embodiment a method for estimating fuel consumption for a vehicle, comprising receiving an origination point and a desired destination from a mobile electronic device. The origination point and the desired destination may be used in a Geographical Routing application program interface (“mapping API”) to obtain information necessary to estimate the fuel consumption used from the origination point to the desired destination. The mapping API may calculate at least one route to drive between the origination point and the desired destination. The mapping API or other source may also provide a set of contextual driving information for the route or multiple routes to the desired destination. The contextual driving information may comprise at least one of at least one driving route from the origination point to the desired destination, a plurality of geographic coordinates defining the driving route, and estimated vehicle speed data at the geographic coordinates.

From this information, a fuel consumption factor may be calculated. The method may comprise calculating a fuel consumption factor for the vehicle along a segment between consecutive or any pair of geographic coordinates along the route based upon the contextual driving information. The fuel consumption rate may then be estimated from the fuel consumption factor and the fuel consumption of the vehicle for each segment from the fuel consumption factor, the length of the segment, an estimated city fuel consumption of the vehicle and an estimated highway fuel consumption of the vehicle, for example.

In one embodiment, fuel consumption may also be estimated or predicted for alternate routes from the origination point and the desired destination in the same manner. A preferred route may be selected based upon the results.

In further one embodiment, the preferred route may be selected automatically based on predefined criteria, the predefined criteria may include which route has the lowest predicted fuel consumption, travel time differences between possible routes, distance differences between possible routes, relative cost of tolls between possible routes or a combination of these factors.

In one embodiment, at least one of a vehicle identification number, make and model, year, body style, type of transmission, engine type identifier, and/or other vehicle identification information may be used to retrieve the vehicle specific fuel consumption rates from a database.

In one embodiment, the estimated vehicle speed for each discrete segment may be determined based on one or more of the historical speed, real-time average speed data measured by sensors, and a user's historical average speed in the discrete segment.

In one embodiment, the system and method is implemented through software on a mobile electronic device.

In one embodiment, the preferred route may be modified in real-time based on information received by the mapping API or a variation from the selected route sensed by a GPS device on the mobile electronic device.

Another embodiment is a system for estimating a fuel consumption of a vehicle for driving on a route from a starting point to a destination. The system may include two or more electronic devices in communication with one another. An embodiment of the system for estimating vehicle fuel consumption may include one or more processors. For example, the one or more processor may include a mapping API may be run and accessed from another processor; the starting point and the desired destination may be sent from a processor of the mobile electronic device; and the fuel consumption estimation program may be run on a server on the cloud, for example.

The system includes memory storage device having instructions stored thereon, which when executed by one or more processors and cause the processors to perform the following actions receive a origination point and a desired destination from a mobile electronic device; receive or generate a set of contextual driving information from a mapping API, wherein the set of contextual driving information comprises at least one driving route from the origination point to the desired destination, a plurality of geographic coordinates defining the driving route or driving routes, and vehicle speed data at the geographic coordinates; calculate a fuel consumption factor for the vehicle along a segment between consecutive geographic coordinates along the route based upon the set of contextual driving information; and estimate a segment fuel consumption from the fuel consumption factor, an estimated city fuel consumption of the vehicle and an estimated highway fuel consumption of the vehicle.

The terminology used herein is for the purpose of describing particular embodiments only, and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but, do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. In describing the invention, it will be understood that a number of components, parts, techniques and steps are disclosed. Each of these has individual benefit and each can also be used in conjunction with one or more, or in some cases, all of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### BRIEF DESCRIPTION OF THE DRAWINGS

For an understanding of the present invention, the objects and advantages thereof, reference is now made to the following descriptions taken in connection with the accompanying drawings in which:

FIG. 1 depicts an embodiment of a system for predicting vehicle fuel efficiency according to one embodiment;

FIG. 2 depicts an output from a mapping application program interface showing multiple routes between an origination point and a destination;

FIG. 3 depicts an embodiment of a flowsheet showing the steps of an embodiment of a method of estimating fuel consumption of a vehicle along a route;

FIG. 4 depicts an embodiment of an average speed membership function according to one embodiment;

FIG. 5 depicts an idle time membership function according to one embodiment;

FIG. 6 depicts an embodiment of an acceleration energy membership function according to one embodiment;

FIG. 7 depicts an embodiment of membership functions for the output according to one embodiment; and

FIG. 8 depicts a graph showing the interpolation of fuel consumption of a vehicle based upon speed information; and

FIG. 9 depicts a fuzzy logic math logic flow sheet that may be used in embodiments of the method of estimating fuel consumption along one or more routes from an origination point to a destination.

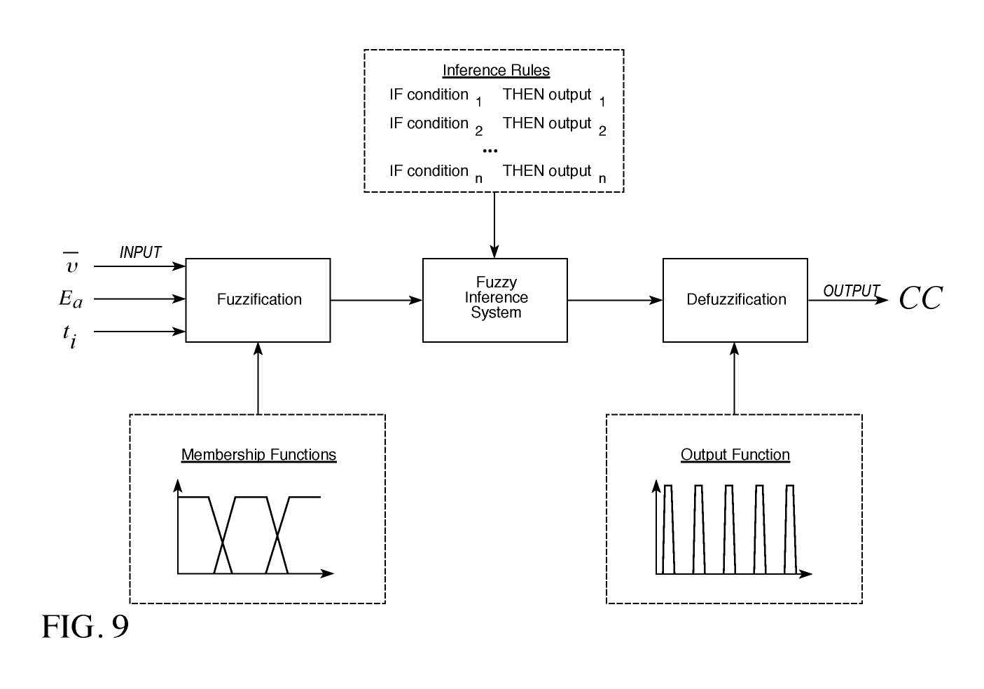

### DETAILED DESCRIPTION OF PREFERRED EMBODIMENTS

In one embodiment, systems and methods for estimating the amount of fuel consumed in an internal combustion engine of a vehicle during travel along a route from an origination point to a destination point or travel along a segment of the route from the origination point to the destination point, or the expected fuel consumption at any point along the route. The systems and methods may be used during travel in real-time, as well as for prediction of fuel consumption on a given path between two coordinates. The estimated fuel consumption may be estimated for multiple routes between the origination point and the destination point and then be compared.

By providing the average consumption levels of a vehicle in urban and highway environments (miles per gallon, liters per 100 km, or other fuel consumption units), the algorithm can estimate how much the vehicle would consume on any coordinate along a path. The algorithm can afterwards sum up all the calculated consumption amounts, to give an estimation of the total fuel consumed when driving this route with the specified vehicle.

A route may be defined by a series of geographic coordinates, typically for driving directions all the geographic coordinates are along roads and at the intersection of roads. Thus, a mapping API such as HERE can be used to generate a driving route between two coordinates or other defined locations.

Embodiments of the method include analyzing the routes output by a mapping API to determine the estimated fuel consumption for each route. The user may then choose between the different routes determined by the mapping API or a route may be selected by predetermined instructions.

In one embodiment, a system and method for estimating fuel consumption along a driving route for a vehicle, comprises receiving an origination point and a desired destination from a mobile electronic device. For example, the mobile electronic device may have a processor and a communication link to the internet or other network to communicate with other processors. The origination point or destination may be entered in any manner known in the art such as, but not limited to, a physical or virtual keyboard, an indicated map location, a chosen search result, or a voice command to the electronic device, for example.

The method may further comprise receiving a set of contextual driving information from an external processor or generating the contextual driving information on the processor of the electronic device. The set of contextual driving information may include one or more driving routes from the origination point to the desired destination, a plurality of geographic coordinates, such as, but not limited to, GPS coordinates along the route or routes, longitude and latitude coordinates or other location descriptions defining the driving route, and vehicle speed data for at least a portion of the geographic coordinates.

From the contextual driving information, one of the processors may calculate a fuel consumption factor for the vehicle along a segment between a pair of geographic coordinates along the route. The pair of geographic coordinates may be consecutive geographic coordinates along the route. The fuel consumption along the segment of the route may then be estimated from the fuel consumption factor, an estimated city fuel consumption of the vehicle and an estimated highway fuel consumption of the vehicle.

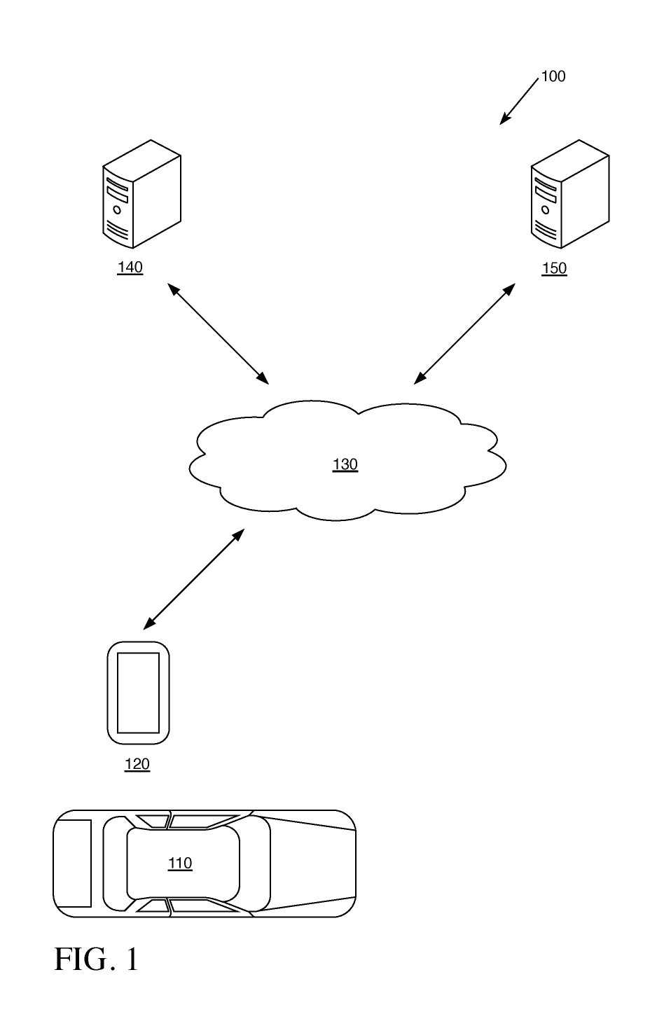

Referring to FIG. 1, a system 100 for predicting vehicle fuel consumption is depicted according to one embodiment. System 100 may include vehicle 110, electronic device 120, one or more network(s) 130, and one or more servers 140 and 150. In one embodiment, electronic device 120 may be a mobile electronic device such as, but not limited to, a smartphone, a tablet computer, a notebook computer, an Internet appliance, etc. In one embodiment, electronic device 120 may be a vehicle-based, or vehicle-embedded electronic device (e.g., a vehicle computer system, a vehicle infotainment system). Any suitable electronic device may be used as necessary.

In one embodiment, electronic device 120 may execute a computer program or computer application (not shown) that may predict fuel consumption for vehicle 110 along a segment of a route or the total fuel consumption for driving the complete extent of the route.

In one embodiment, electronic device 120 may communicate with vehicle 110 wirelessly (e.g., NFC, Bluetooth, etc.) or by a physical connection (e.g., via vehicle 110's onboard diagnostic port through a serial, USB or other type of wired connection).

Network(s) 130 may include any suitable communication and/or data network, including WiFi, wired, NFC, cellular, satellite, Internet, combinations thereof, etc. In one embodiment, network(s) 130 may facilitate communications between electronic device 120 and one or more servers 140 and 150.

In one embodiment, servers 140 and 150 may be remotely located from electronic device 120 and may provide data to electronic device 120. For example, servers 140 and 150 may host one or more database that may store vehicle characteristics regarding a plurality of vehicles, including vehicle 110. Also, servers 140 and 150 may host several API, including a mapping API to provide a route and, optionally, route alternatives between an origination point and destination of vehicle 110. Also, at least one of servers 140 and 150 may host a Geographical. Map-Matching API that is able to provide contextual driving information for routes requested by vehicle 110. Such an API may use services such as, but not limited to, HERE Maps Services or Google Maps Services, for example, the mapping API and the Geographic Map Matching API may be the same API or reside on the same server or server service. Such contextual driving information may include: road type information, road slope information, road curvature information, live, historical and crowd-sourced traffic information, speed limit information, weather information, etc. It may also indicate road incidents information for roads along the route to decide on recalculate fuel consumption on the route, calculate other available routes, change the current route or re-routing during a trip. Any available information that may have an impact on fuel consumption of a vehicle may be provided as is necessary and/or desired. Also, servers 140 and 150 may host a Vehicle Information API that can provide detailed technical parameters from vehicle 110 that are needed for the calculation of fuel consumption. Such parameters may include, but not limited to, make, model, urban fuel consumption information, engine type, highway fuel consumption information, and additional fuel consumption information, for example.

In one embodiment, electronic device 120 may provide data to one or more servers 140 or 150. For example, an electronic device may push traffic data, vehicle data, actual vehicle performance data, fuel consumption data of the vehicle, past experience data, weather data to one or more servers 140 or 150 for processing and aggregation. In one embodiment, one or more servers 140 or 150 may provide some or all of this data to other mobile devices.

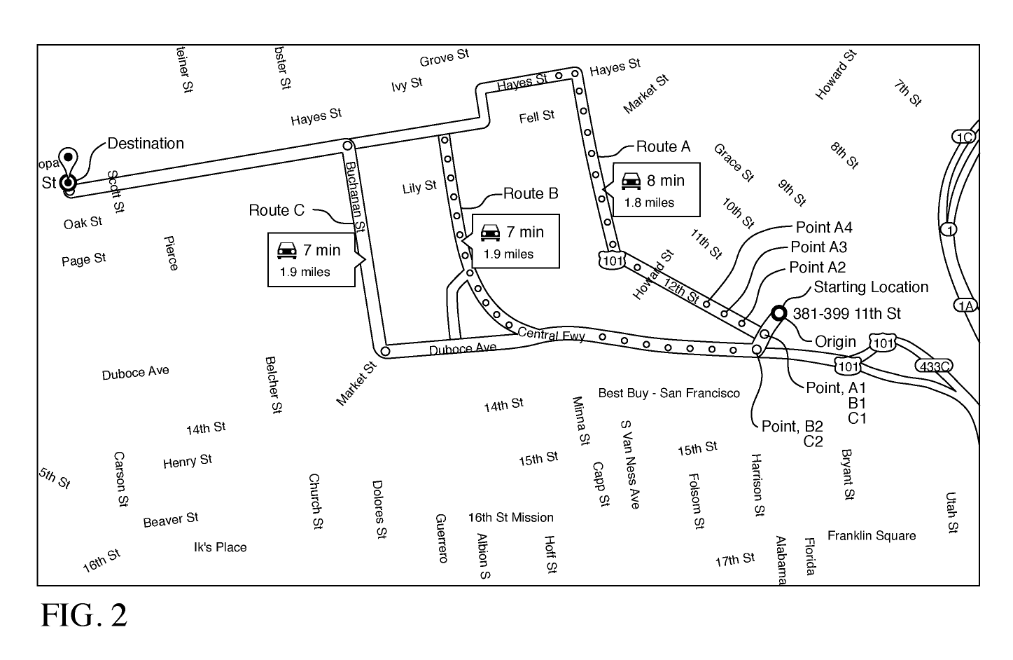

A map representation of the output of the different routes from a mapping API for the same origination point and a desired destination is shown in FIG. 2. The map depicts three preferred routes (Route A, Route B, and Route C) wherein each route is defined by a series of geographic coordinates. For Route A, the route is defined by a series of geographic coordinates (Points A1, A2, A3, etc.) and similarly for Route B (Points B1, B2, B3, etc.) and Route C (Points C1, C2, C3, etc.). The preferred routes, Route A, Route B and Route C, were determined by the Mapping API to be the shortest distance or shortest time to get from the origination point to the desired destination. The output of the mapping API may also include the contextual driving information associated with at least a portion of the geographic coordinates. In one embodiment, the contextual driving information for each geographic coordinate along each of the routes includes an estimated vehicle speed and the geographic coordinates of the point along the route. For example, the first nine points and the associated contextual driving information along Route B are shown in Table 1.

TABLE 1
Geographic coordinates and Driving Information

| | Vehicle | GPS | | Driving | Approximate |
|---|---|---|---|---|---|
| Point | Speed, m/s | coordinates | Elevation, m | Distance, m | Acceleration, m/s2 |
| B0 | 10 | 37.7709, −122.4128 | 24 | — | — |
| B1 | 8 | 37.7706, −122.4124 | 23 | 50 | −0.36 |
| B2 | 8.5 | 37.7703, −122.4129 | 18 | 50 | 0.0825 |
| B3 | 12.5 | 37.7700, −122.4131 | 15 | 50 | 0.84 |
| B4 | 12.5 | 37.7695, −122.4134 | 15 | 50 | 0 |
| B5 | 3 | 37.7695, −122.4138 | 18 | 50 | −1.4725 |
| B6 | 18 | 37.7696, −122.4144 | 16 | 50 | 3.15 |
| B7 | 17.5 | 37.7696, −122.4150 | 15 | 50 | −0.1775 |

In Table 1, contextual driving information received from the mapping API and information calculated form the contextual driving information is shown. In this embodiment, the contextual driving information includes the estimated vehicle speed, the GPS coordinates and, optionally, the elevation of the land at each GPS location. The driving distance or length of the segment between consecutive points is calculated between the GPS coordinates by known methods. In this embodiment, the acceleration is calculated from the vehicle speed data at consecutive points and the distance between the points.

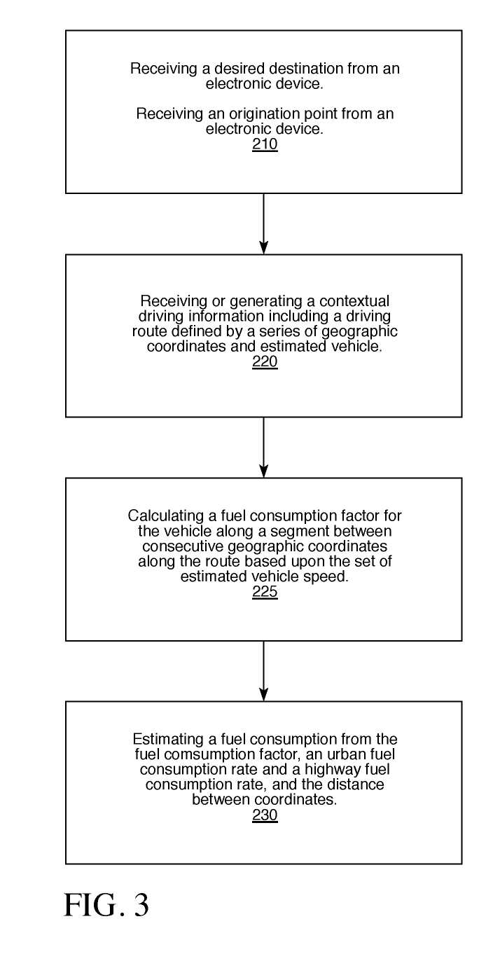

A method for predicting vehicle fuel consumption is disclosed according to one embodiment as shown in FIG. 3. In step 210, a user may determine a destination point and enter it into an application executed by an electronic device 120, such as a smartphone, tablet computer, notebook computer, vehicle-based computer system, etc., for example. The origination point may also be entered by the user or obtained by a GPS chip in the electronic device. In other cases, the destination point may be received from a remote processor such as, but not limited to, a mapping API, a business or other web site, an email, or a text message, for example.

In step 220, the application may request a mapping API hosted in server 140 or 150 or on the electronic device 120, for example, to obtain one or more routes for a given origination and destination point of vehicle 110. For example, HERE Maps or Google Maps Services may be used. The application may also request a locally hosted mapping API on electronic device 120, like the MKDirections API from Apple, etc, for example. Other mapping APIs may be used as necessary and/or desired.

In one embodiment, the mapping API may calculate and return one or more routes to the destination point such as shown in FIG. 1, with each route including a set of instructions. The geographical coordinates of the route define a series of road segments between consecutive coordinates used in the fuel consumption estimation. A road segment may be determined by consecutive geographic coordinates along the route and may belong to one or more road types (highway, motorway, primary network, secondary network, residential area, etc.). The mapping API may also provide the contextual driving information associated with the geographical coordinates and communicate them to a processor in the system.

In step 220, the mapping API or other source may provide contextual driving information concerning the vehicle speed and geographic coordinates to use in the fuel consumption calculator for each geographical point along the route. The vehicle speed may be the current speed reported by speed sensors, the current speed limit, an average speed, a historical suitable speed, or an estimated speed. A historical suitable speed may be calculated by considering legal speed limit, historical traffic, weather, or road curvature profile. The historical suitable speeds may also include historical user driving behavior on these road segments, or generally. Also, information about the slope profile or elevation of each road segment may be provided by the mapping API.

In at least one embodiment, the vehicle speeds retrieved from the mapping API to calculate an estimated acceleration during each road segment.

In one embodiment, after updating the distance of the segment and acceleration, the process moves to the next step.

Referring again to FIG. 2, in step 225, a fuel consumption prediction for the route(s) may be predicted based on the speed, length of the segment of the route, and acceleration. In one embodiment, vehicle parameters may be considered in the prediction. For example, vehicle parameters, such as, urban fuel consumption, highway fuel consumption, vehicle idle fuel consumption, and vehicle maximum fuel consumption, for example, may be considered, for example.

In step 225, one or more of the parameters may be retrieved from a database based on a Vehicle Identification Number (VIN) of vehicle 110. In one embodiment, vehicle parameters can be retrieved through an external Vehicle Information API, hosted in servers 140 or 150. Such a Vehicle Information API may require as input the VIN or any other set of information that allows to identify the vehicle (e.g., make, model, year). The Vehicle Information API returns as output the technical vehicle parameters required by the fuel consumption model.

In step 230, the fuel consumption may be estimated from the fuel consumption factor, an urban fuel consumption rate and a highway fuel consumption rate, and the distance between coordinates.

Embodiments of the systems and methods associate a value to the type of road a given coordinate is located on. The inputs of this algorithm are shown in Table 2:

| Parameter | Description | Units |
|---|---|---|
| v | Vehicle speed for the given coordinate | m/s |
| tᵢ | Idle time on the segment | s |
| Eₐ | Energy of acceleration | m²/s⁴ |

A suitable equation for calculating energy of acceleration is:

Eₐ[n]=a²[n−1]−a[n]*a[n−2]

where Eₐ and a represent the energy of acceleration and acceleration itself, respectively. This entry of the Fuzzy Inference System infers that if the energy of acceleration is high, the area is likely a heavy traffic area, since it is necessary to accelerate and decelerate frequently.

In one embodiment, the energy of acceleration at the geographic coordinates of a route can be computed using a moving average filter. An example of usage of such a filter is disclosed in Y. L. Murphey, Park Jungme, Chen Zhihang, M. L. Kuang, M. A. Masrur, and A. M. Phillips, “Intelligent hybrid vehicle power control—part i:Machine learning of optimal vehicle power”, Vehicular Technology, IEEE Transactions on, 61(8):3519-3530, 2012, the disclosure of which is hereby incorporated by reference in its entirety.

For example, a filter of fifty data points may be used. In one embodiment, this filter may be combined with the value in the previous instant to yield a greater perception of the variation. An example equation represents this filter:

$$\overline{x} ( t ) = α x ( t - 1 ) + \frac{1 - α}{N} {\sum }_{i = 0}^{N - 1} x ( t - i )$$

In one embodiment, N=50, and α=0.2. N and α may be defined differently for different embodiments. In one embodiment, an output may be defined between 0 and 100, where each interval is assigned a type of cycle.

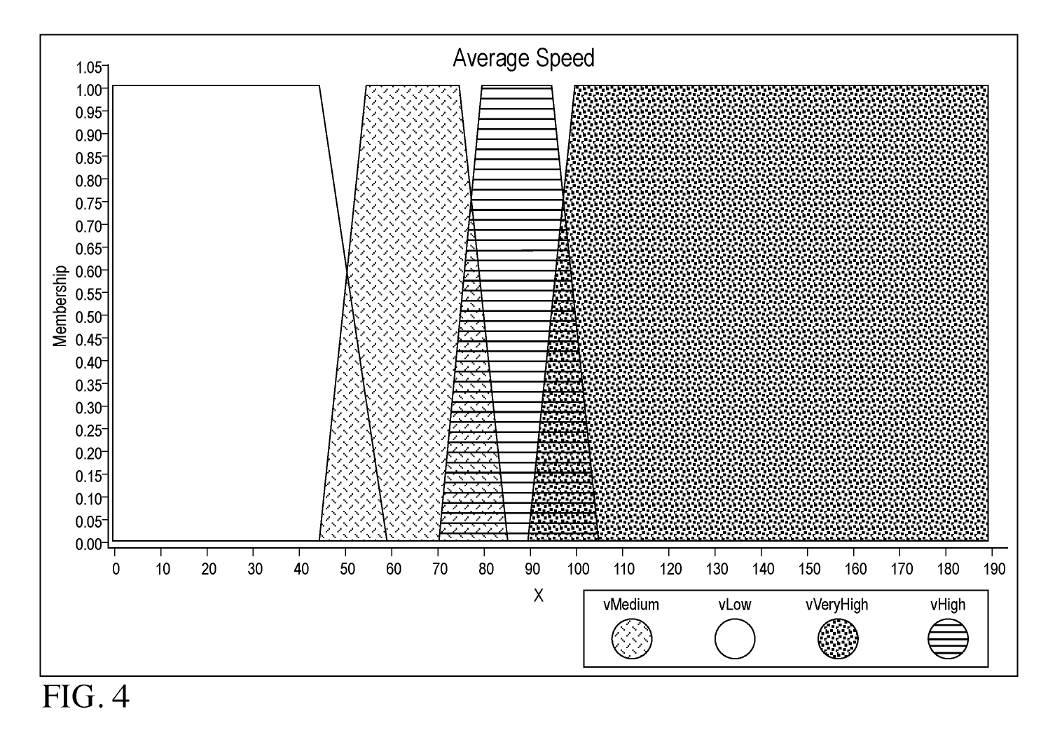

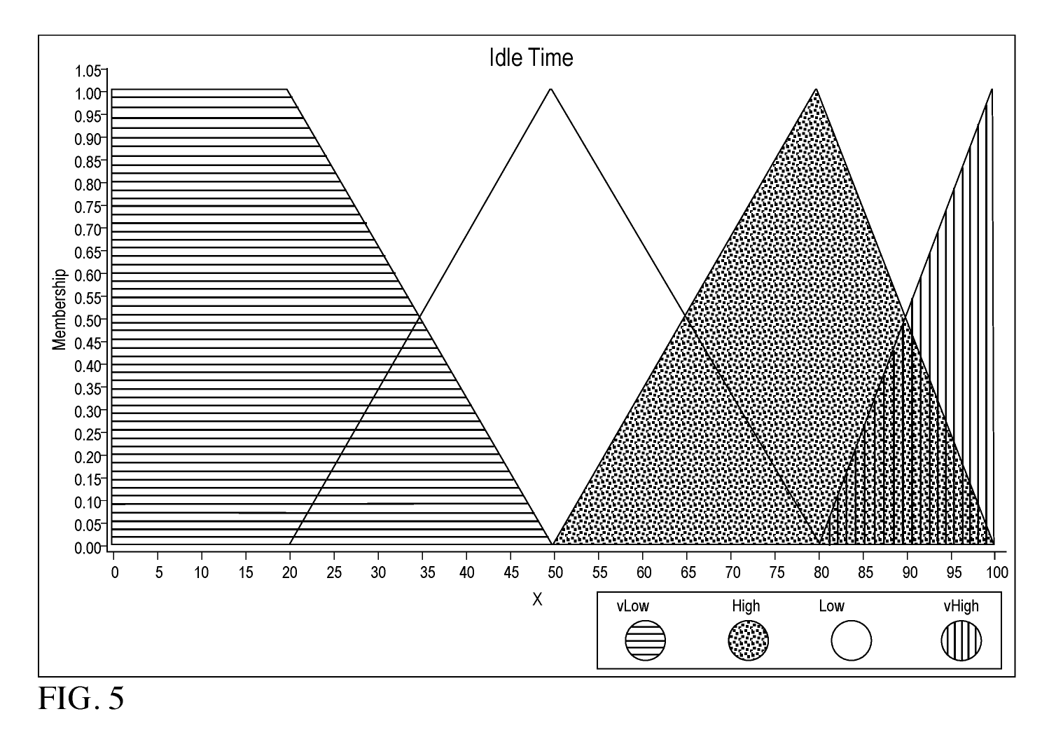

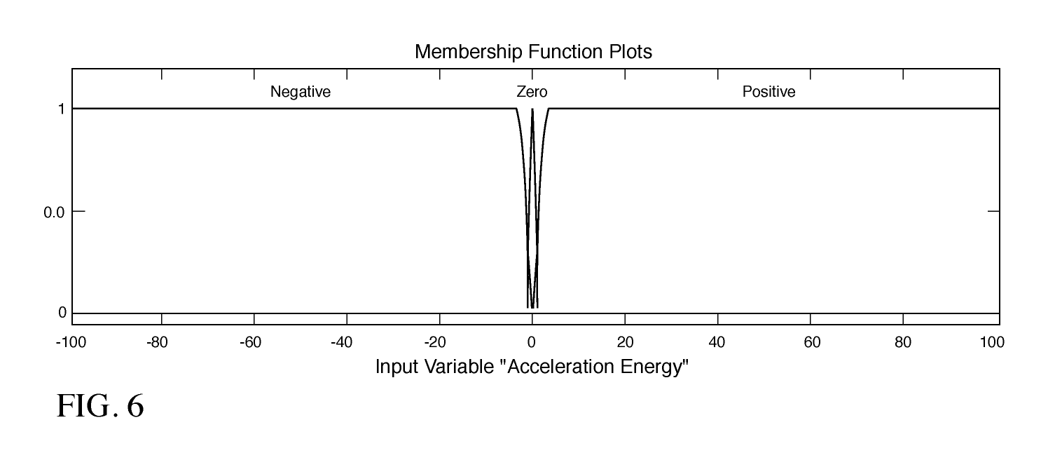

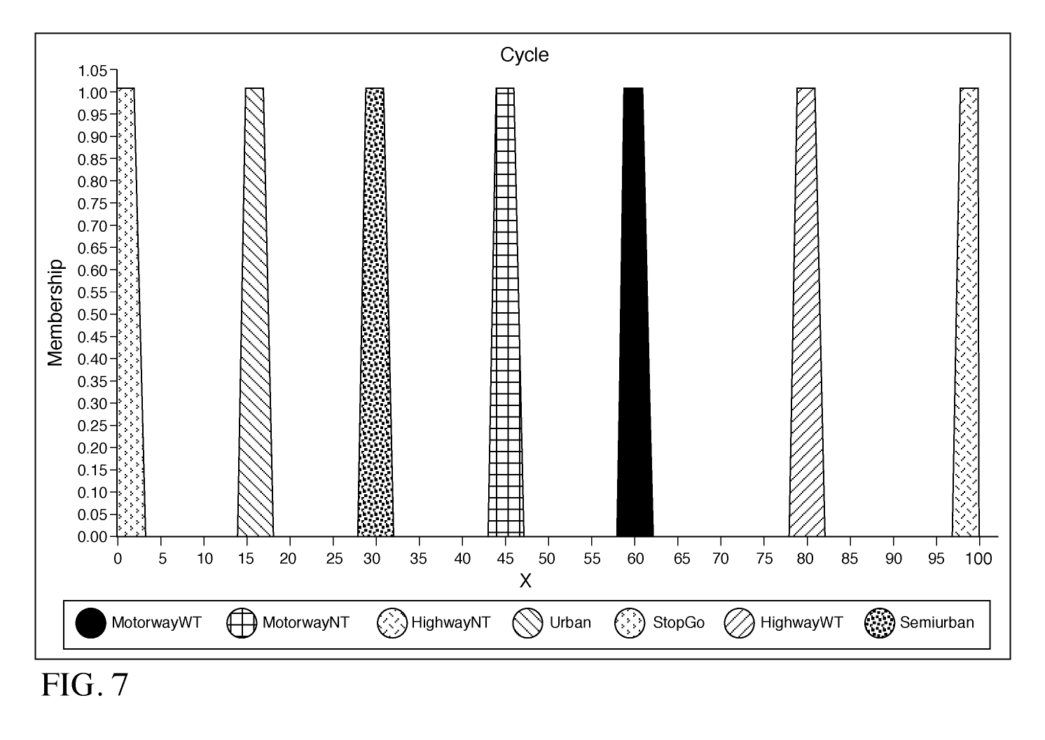

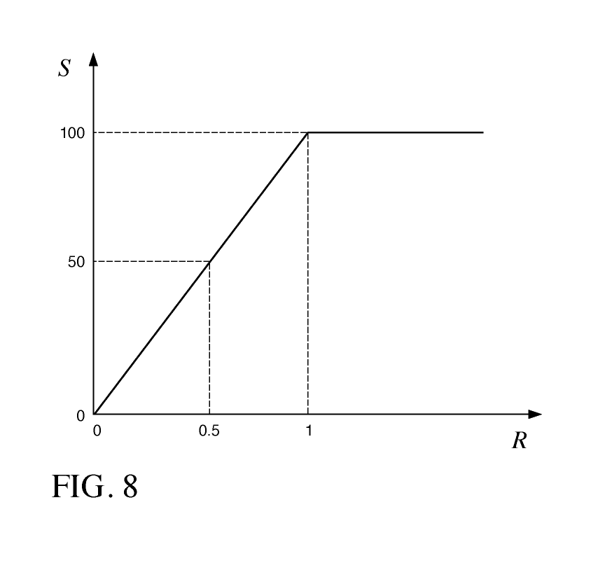

Based on the previously defined inputs (average speed, idle time, and acceleration energy) a Fuzzy System is defined in FIG. 8. The following membership functions are defined. FIG. 4 represents the average speed membership function according to one embodiment, FIG. 5 represents the idle time membership function according to one embodiment; FIG. 6 represents an acceleration energy membership function according to one embodiment, and FIG. 7 represents the membership functions for the output according to one embodiment.

A fuzzy system is defined with the following input variables (all terms have trapezoid shape):

| Variable | Term | A | B | C | D |
|---|---|---|---|---|---|
| averageSpeed | vLow | — | 0 | 45 | 60 |
| | vMedium | 45 | 55 | 75 | 85 |
| | vHigh | 70 | 80 | 95 | 105 |
| | vVeryHigh | 90 | 100 | 250 | — |
| idle | Low | — | 0 | 15 | 30 |
| | High | 20 | 45 | 100 | — |
| averageAccelerationEnergy | Negative | — | −100 | −2.5 | −0.2 |
| | Zero | −1 | −0.3 | 0.3 | 1 |
| | Positive | 0.2 | 2.5 | 100 | — |

The output variable of the system (drivingCycle) is defined as:

| Term | A | B | C | D |
|---|---|---|---|---|
| stopGo | — | 0 | 2 | 3 |
| Urban | 14 | 15 | 17 | 18 |
| SemiUrban | 28 | 29 | 31 | 32 |
| motorwayNT | 43 | 44 | 46 | 47 |
| motorwayWT | 58 | 59 | 61 | 62 |
| highwayWT | 78 | 79 | 81 | 82 |
| highwayNT | 97 | 98 | 100 | — |

The rules of the system are defined as:
if averageSpeed is vLow and idle is High then drivingCycle is stopGo
if averageSpeed is vMedium then drivingCycle is SemiUrban
if averageSpeed is vLow and idle is Low then drivingCycle is Urban
if averageSpeed is vVeryHigh and averageAccelerationEnergy is Zero then drivingCycle is highwayNT
if averageSpeed is vVeryHigh and averageAccelerationEnergy is Positive then drivingCycle is highwayWT
if averageSpeed is vVeryHigh and averageAccelerationEnergy is Negative then drivingCycle is highwayWT
if averageSpeed is vHigh and averageAccelerationEnergy is Positive then drivingCycle is motorwayWT
if averageSpeed is vHigh and averageAccelerationEnergy is Negative then drivingCycle is motorwayWT
if averageSpeed is vHigh and averageAccelerationEnergy is Zero then drivingCycle is motorwayNT

The other parameters of the fuzzy mathematics system are:

Centroid defuzzifier with resolution: 200

Accumulation: Maximum

Range: 0-100

Conjunction: Minimum

Disjunction: Maximum

Activation: Algebraic Product

In one embodiment, the membership functions may be set so that the most approximate cycles stay identical. Thus, the output value increases with the increase of the average speed, with cycles with high traffic are also placed consecutively, since they have similar properties.

Based on the membership functions, Tables 4 and 5 provide the Inference Rules that may be used to infer the type of driving cycle.

In another embodiment, the application may automatically select the route with the lowest total fuel consumption estimation.

After defining the method for drive cycle estimation, we will utilize it to estimate the amount of fuel consumed in each sample (i.e. coordinate). For each new coordinate, the system and method will calculate the parameters shown in Table 3:

TABLE 3

| Parameter | Description | Units |
|---|---|---|
| Δd | Distance from last sample | m |
| U | Average urban consumption | L/100 km |
| H | Average highway consumption | L/100 km |
| C | Estimated drive cycle | — |

Drive cycles below 30 are defined as urban, and drive cycles above 75 are defined as highway. For intermediate values, the average consumption value for the segment is calculated based upon a linear interpolation between or extrapolation from the urban fuel consumption rate and highway fuel consumption rate, as follows:

$$α = \frac{C - 30.0}{75.0 - 30.0}$$

$$φ = α \cdot H + ( 1 - α ) \cdot U$$

Finally, the amount of fuel consumed for the sample is calculated as:

F=φΔd/100,000 liter

The division by 100,000 is due to having the consumption units in L/100 km, and the distance in meters. Therefore, we divide by 100×1,000=100,000. These calculations can be easily converted to the American unit system by using known conversion factors.

The sum of this result for each coordinate is the overall estimated consumption in liters. The accuracy of algorithm increases by increasing the number of geographic coordinates on a path, as well as providing realistic average consumption values for urban and highway environments. Since usually the manufacturer provided consumption values are less than in real-life, either users can provide feedback on how much their car consumes, and the system can be adapted to those values. Another approach would be to add an arbitrary value to the final output value or multiply the final output value by a correction factor to avoid underestimation and user dissatisfaction.

In one embodiment, in step 245, the application may provide route guidance for the selected route. In another embodiment, the application may launch a separate navigation application to provide route guidance over a map. In still another embodiment, the application may interface with an on-board vehicle navigation or infotainment system and provide the route to the on-board vehicle navigation system. This interface between the application and on-board system may use existing protocols as Apple CarPlay, Android MirrorLink, Android Auto, etc.

In one embodiment, the system may decide to provide re-routing options to drivers during the ongoing trip. Such a decision may be based on systematic deviation from the predicted fuel consumption due to start-stop behavior caused, for instance, by heavy traffic situations.

The disclosure of U.S. patent application Ser. Nos. 14/529,100 and 15/423,754 are hereby incorporated, by reference, in its entirety.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netwarer™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that, provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions, That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing, machine, utilized to hold the set of instructions and/or the data used in the invention may take on any of a variety of physical forms or transmissions, for example, Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for estimating fuel consumption for a vehicle, comprising:
receiving a origination point and a desired destination from a mobile electronic device;
receiving or generating a set of contextual driving information, wherein the set of contextual driving information comprises a driving route from the origination point to the desired destination, a plurality of geographic coordinates defining the driving route, and vehicle speed data at the geographic coordinates;
calculating a fuel consumption factor for the vehicle along a segment between consecutive geographic coordinates along the route based upon the set of contextual driving information; and
estimating a segment fuel consumption from the fuel consumption factor, an estimated city fuel consumption of the vehicle and an estimated highway fuel consumption of the vehicle.

2. The method of claim 1, further comprising receiving or generating a second set of driving wherein the second set of contextual driving information comprises a second driving route from the origination point to the desired destination, a plurality of second geographic coordinates defining the second driving route, and vehicle speed data for the second geographic coordinates;
calculating a second fuel consumption factor for the vehicle along a segment between consecutive geographic coordinates along the route based upon the second set of contextual driving information; and
estimating a segment fuel consumption from the fuel consumption factor, an estimated city fuel consumption of the vehicle and an estimated highway fuel consumption of the vehicle.

3. The method of claim 1, wherein estimating a segment fuel consumption comprises estimating a vehicle acceleration from the vehicle speed data for consecutive geographic coordinates.

4. The method of claim 3, wherein estimating a segment fuel consumption comprises estimating a vehicle idle time from the vehicle speed data and distance between consecutive geographic coordinates.

5. The method of claim 4, further comprising calculating an energy of acceleration from the vehicle acceleration at least three consecutive geographic coordinates.

6. The method of claim 5, further comprising:
applying a correction factor to the fuel consumption prediction.

7. The method of claim 5, wherein estimating a segment fuel consumption with filtered idle time and filtered energy of acceleration.

8. The method of claim 1, wherein a vehicle identification number of the vehicle is used to retrieve the estimated city fuel consumption of the vehicle and the estimated highway fuel consumption of the vehicle from a database.

9. The method of claim 1, wherein estimating a segment fuel consumption from the fuel consumption factor, an estimated city fuel consumption of the vehicle and an estimated highway fuel consumption of the vehicle comprises interpolating a segment fuel consumption rate from the estimated city fuel consumption of the vehicle and an estimated highway fuel consumption of the vehicle.

10. A system for predicting fuel consumption for a vehicle, the system comprising:
one or more processors,
memory having instructions stored thereon, which when executed by the one or more processors, cause the processors to perform the following actions:
receive a origination point and a desired destination from a mobile electronic device;
receive or generate a set of contextual driving information from a mapping API, wherein the set of contextual driving information comprises a driving route from the origination point to the desired destination, a plurality of geographic coordinates defining the driving route, and vehicle speed data at the geographic coordinates;
calculate a fuel consumption factor for the vehicle along a segment between consecutive geographic coordinates along the route based upon the set of contextual driving information; and
estimate a segment fuel consumption from the fuel consumption factor, an estimated city fuel consumption of the vehicle and an estimated highway fuel consumption of the vehicle.

11. The system of claim 10, further comprising receiving or generating a second set of driving wherein the second set of contextual driving information comprises a second driving route from the origination point to the desired destination, a plurality of second geographic coordinates defining the second driving route, and vehicle speed data for the second geographic coordinates;
calculating a second fuel consumption factor for the vehicle along a segment between consecutive geographic coordinates along the route based upon the second set of contextual driving information; and
estimating a segment fuel consumption from the fuel consumption factor, an estimated city fuel consumption of the vehicle and an estimated highway fuel consumption of the vehicle.

12. The method of claim 10, wherein estimating a segment fuel consumption comprises estimating a vehicle acceleration from the vehicle speed data for consecutive geographic coordinates.

13. The method of claim 12, wherein estimating a segment fuel consumption comprises estimating a vehicle idle time from the vehicle speed data and distance between consecutive geographic coordinates.

14. The method of claim 13, further comprising calculating an energy of acceleration from the vehicle acceleration at least three consecutive geographic coordinates.

15. The method of claim 14, further comprising:
applying a correction factor to the fuel consumption prediction.

16. The method of claim 14, wherein estimating a segment fuel consumption with filtered idle time and filtered energy of acceleration.

17. The method of claim 10, wherein a vehicle identification number of the vehicle is used to retrieve the estimated city fuel consumption of the vehicle and the estimated highway fuel consumption of the vehicle from a database.

18. The method of claim 10, wherein estimating a segment fuel consumption from the fuel consumption factor, an estimated city fuel consumption of the vehicle and an estimated highway fuel consumption of the vehicle comprises interpolating a segment fuel consumption rate from the estimated city fuel consumption of the vehicle and an estimated highway fuel consumption of the vehicle.
